(19) United States
(12) Patent Application Publication
(10) Pub. No.: US 2010/0265196 A1
(43) Pub. Date: Oct. 21, 2010

(54) METHOD FOR DISPLAYING CONTENT OF TERMINAL HAVING TOUCH SCREEN AND APPARATUS THEREOF

(75) Inventors: Bong Won Lee, Seoul (KR); Kyoung Sik Yoon, Gyeonggi-do (KR); In Won Jong, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/748,544

(22) Filed: Mar. 29, 2010

(30) Foreign Application Priority Data
Apr. 16, 2009 (KR) 10-2009-0033002

(51) Int. Cl. G06F 3/041

(52) U.S. Cl. 345/173

(57) ABSTRACT

Provided is a method of displaying one or more content of a terminal having a touch screen, which includes executing a mode for changing a display state of one or more content; associating a gesture inputted by user with the display state of the content; and displaying one or more content in response to the gesture.

### CLAIM OF PRIORITY

This application claims the benefit of the earlier filling date, under 35 U.S.C. §119, from patent application serial no. 10-2009-0033002 filed in the Korean Intellectual Property Office on Apr. 16, 2009, the contents of which are incorporated by reference in its entirety, herein.

### BACKGROUND OF THE INVENTION

1. Field of the Invention

The present invention relates to a method and apparatus for displaying content of a terminal, and more particularly, to a method and apparatus for displaying one or more content according to a user's input via a touch screen.

2. Description of the Related Art

Nowadays, an area of a service using a terminal includes voice call service, short message service, and various other services. The terminal now can provide multimedia services, in addition to the traditional text-oriented services, due to the improvement of data transmission speed and the development of network technologies. As the demand for multimedia service is increased, the terminal must now provide various types of content. Particularly, the utilization of various content, such as MP3 MPEG Audio Layer-3 content and photograph/video content, has rapidly increased. Currently, location of content displayed in the terminal screen is preset. However, a user cannot arrange or display the content as desired by a user.

Accordingly, there is a need to enable a user to relocate the media content at a desired location and format, thus enhancing use convenience.

### SUMMARY OF THE INVENTION

The present invention is made in view of the above problems, and provides a method and apparatus for displaying one or more content of a terminal having a touch screen by generating locus corresponding to movement (or gesture) inputted by a user, and arranging the content by associating the display state of content with the locus. The locus is a path for coordinate values corresponding to the gesture of a user.

In accordance with another aspect of the present invention, a method of displaying content of a terminal comprising a touch screen includes: executing a mode for changing a display state of one or more content; associating a gesture inputted by a user with the display state of the content; and displaying one or more content according to the gesture.

In accordance with an aspect of the present invention, an apparatus for displaying one or more content of a terminal: a touch screen having a touch pad and a display window for displaying one or more content according to a preset arrangement; and a controller which executes a mode for changing a display state of the one or more content, associates a gesture inputted by user with the display state of the content, and changes the display state of the one or more content in response to the gesture.

According to the present invention, a user can input a desired outlook of one or more content via a touch screen, so one or more content can be arranged within locus that matches the desired outlook. Additionally, the gesture of a user and the display state of content are associated to intuitively arrange one or more content, so that the content can be easily checked or reviewed.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a terminal according to an exemplary embodiment of the present invention;

FIG. 2 is a flowchart illustrating a process of arranging and displaying content according to user's gesture in accordance with an exemplary embodiment of the present invention;

FIG. 3 is a flowchart illustrating an operation of layout change mode according to an exemplary embodiment of the present invention;

FIGS. 4a and 4b are screens illustrating an operation of layout change mode according to an exemplary embodiment of the present invention;

FIG. 5 is a flowchart illustrating a locus generation process corresponding to user's gesture according to an exemplary embodiment of the present invention;

FIG. 6 is a screen illustrating a locus generation process corresponding to user's gesture according to an exemplary embodiment of the present invention; and

FIGS. 7a to 7f are screens arranging content in response to user's gesture according to an exemplary embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

In the exemplary embodiment of the present invention, ‘content’ refers to all types of digital information provided through communications network such as internet, or is stored in a terminal for a subsequent review on the screen of a terminal. It should be noted that a photograph is used for illustrative purposes. However, the content of the present invention is not limited to photographs but various other contents can be included as described above.

In the exemplary embodiment of the present invention, ‘locus’ refers to a route which is formed by coordinates corresponding to a touch signal inputted by a user via a touch screen. The locus is detected by corresponding movement route from a touch start coordinate value inputted by a user to a touch termination coordinate value inputted by a user, then generated as a locus standardized through a process of correction based on a locus that is previously set in terminal. Thereafter, the corrected locus can be converted to locus of three-dimensional shape (space locus).

In the exemplary embodiment of the present invention, ‘gesture’ refers to a continuous movement action inputted via a touch screen. A set of gesture can be pre-stored in the terminal for comparison. For example, a terminal can distinguish a gesture of a curve shaped touch and a straight line shaped touch. However, the gesture is not limited to a straight line operation and a curve operation, but can include various forms of shape which can be inputted via a touch screen.

The terminal according to an exemplary embodiment of the present invention is a terminal having a touch screen and capable of displaying content and may include a mobile communications terminal, a Personal Digital Assistants (PDA), a Smart phone, an International Mobile Telecommunication 2000 (IMT-2000) terminal, a Code Division Multiple Access (CDMA) terminal, a Global Standard for Mobile Communication (GSM) terminal, a Wideband Code Division Multiple Access (WCDMA) terminal, a Potable Multimedia Player (PMP) terminal, a navigation terminal and a notebook or the like.

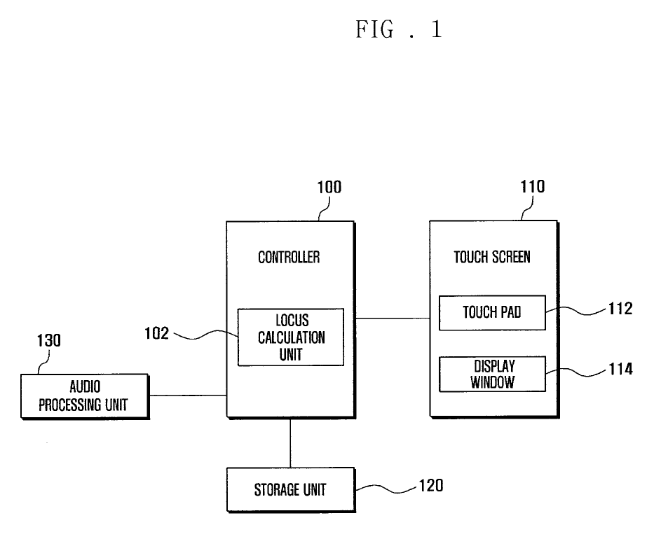

FIG. 1 is a block diagram illustrating a configuration of a terminal according to an exemplary embodiment of the present invention.

Referring to FIG. 1, the terminal includes a touch screen 110, a storage unit 120, an audio processing unit 130, and a controller 100. The controller 100 includes a locus calculation unit 102, and the touch screen 110 includes a touch pad 112 and a display window 114. Here, the touch pad 112 can be comprised of a touch sensor equipped with a touch detection unit (not shown) and a signal conversion unit (not shown).

In operation, the touch detection unit detects a signal on or about thereof according to the change of corresponding physical quantity, e.g., the change of resistance or electrostatic capacity. The signal conversion unit converts the change of physical quantity into a touch signal. If the touch signal of a user is generated in a layout change mode for changing display state of one or more content, the touch pad 112 of the present invention detects coordinate values included within points from a point where initial touch signal is sensed to a point where touch signal is terminated according to a direction in which user's gesture moves. Note that the layout change mode refers to a mode when a user interact the touch screen to change the appearance of the screen layout showing one or more content for convenience.

The display window 114 displays various information related with the state and operation of the terminal. The display window 114 is implemented as a liquid crystal display (LCD), and includes a LCD controller and a LCD display device. Particularly, the display window 114 of the present invention can display the request of a user. Moreover, in the layout change mode, the display window 114 displays locus corresponding to a gesture which the user inputs with overlay, and arranges one or more content according to locus corresponding to the gesture for display.

The storage unit 120 stores application programs necessary for the operation of function according to an exemplary embodiment of the present invention. The storage unit 120 includes a program area and a data area. Particularly, the program area can store an operating system (OS) which boots terminal, a program which executes the layout change mode to change and arrange the display state of one or more content in response to a touch signal from a user, a program which calculates locus by utilizing coordinate values corresponding to a gesture by a user, a program which corrects the locus into a locus having a preset shape, a program which determines the corrected locus is similar to a plurality of locus shape which are previously stored, and a program which converts the corrected locus into a space locus which is three-dimensional shape. The program area can store a program which changes at least one of a size of the content and a darkness of the content to display one or more content in three dimensions.

In the meantime, the data area is an area where user data relating to various option functions can be stored. Particularly, the data area of the present invention can store various types of content information, information about locus which can be used in terminal, information about locus having preset shape, and coordinate value corresponding to the gesture inputted by a user during a layout change mode.

The audio processing unit 130 performs the function of playing audio signal or sending audio signal (e.g., user voice) inputted from a microphone (MIC) to the controller 100. At this time, the audio processing unit 130 converts an audio signal into an audible sound through a speaker (SPK) and outputs it, and converts an analog signal received from the microphone (MIC) into a digital signal and outputs it. Particularly, if a gesture is generated by a user in the layout change mode, the audio processing unit 130 of the present invention can output sound effect while arranging the content according to corresponding locus.

The controller 100 controls the overall operation of terminal and a signal flow between the internal blocks. Particularly, the controller 100 of the present invention can control the display window 114 to display the content stored in terminal in response to a user's request. Moreover, the controller 100 can execute the layout change mode in response to a request to change the display state of one or more content. A request for executing the layout change mode can be activated by the touch signal generated over a preset time in a specific content among one or more content displayed on screen. The preset time can be set and stored during the terminal manufacturing process. In an alternate embodiment, a request signal for the execution of layout change mode can be applied using other type of touch signal that is previously set in the terminal.

The controller 100 can associate the gesture inputted from a user with the display state of content. That is, the controller 100 can control the display window 114 to arrange and display one or more content in response to gesture inputted by the user. When the touch signal is generated and terminated, the controller 100 arranges and displays the content at a location where the touch signal is generated. Thereafter, the controller 100 can execute the layout change mode. If the layout change mode is executed, the controller 100 can control the storage unit 120 to store coordinate values corresponding to the gesture inputted by user. The controller 100 can perform the process of calculating pertinent locus by analyzing coordinate values corresponding to user's gesture stored in the storage unit 120, and then perform the process of correcting the locus. The process of correcting the locus involves generating corrected locus by correcting coordinate values corresponding to the gesture of a user within a certain range previously set in the terminal via a correction program. Thus, the locus by the gesture of a user can be corrected into a standardized locus shape, which is used to arrange one or more content. For example, even if a gesture of perfect circle shape is not input, the controller may recognize that a locus of circle shape is input. After the correction, the controller 100 can control the display window 114 to display the locus in the screen.

Thereafter, the controller 100 can compare corrected locus with prestored locus. To this end, the storage unit 120 can previously store information about gesture having a curve shaped user's touch signal and gesture having a straight line shaped user's touch signal. If the corrected locus is similar to a prestored locus shape, the controller 100 performs the process of converting the locus into a space locus which is three-dimensional shape to display one or more content in three dimensions. To this end, the controller 100 can control the locus calculation unit 102 and perform the conversion of the locus. The locus calculation unit 102 may add height (z axis) to plane coordinates value which is comprised of width (x axis) and length (y axis) which are inputted from the touch screen 110. The locus calculation unit 102 is increased value of height (z axis) by preset value (e.g. 1). For example, The locus calculation unit 102 adds height value “0” to a first (start) coordinate, adds height value “1” to a second coordinate, and adds height value “2” to a third coordinate. If a entire plane coordinates exist 20, the locus calculation unit 102 adds height value “19” to last coordinate. The more height value of coordinate is increased, the more the coordinate is far away from user.

The controller 100 can change at least one of a size and a darkness of the content to display one or more content in three dimensions. For example, the controller 100 displays content to be larger or to be brighter in a start coordinate value of the locus, while displaying content to be smaller or to be darker as it goes away from the start coordinate value. As a result, one or more content can be rearranged in three dimensions according to locus corresponding to user's gesture. Finally, the controller 100 can store the changed arrangement information of the content in the storage unit 120. The changed arrangement information of the content is stored to display the content according to the previously stored the arrangement information of the content when the content is displayed again by a user.

Moreover, in the exemplary embodiment of the present invention, the controller 100 can further rearrange and display one or more content in response to a rotating operation of the terminal in the state where content is displayed according to the detected gesture. The controller 100 senses the rotation direction of terminal via a sensor (not shown), such as geomagnetic sensor, and then rearrange and display content according to the detected rotation direction in the screen. The controller 100 includes the locus calculation unit 102 so as to effectively perform such function. Particularly, the locus calculation unit 102 obtains coordinate values corresponding to the gesture of user, and can generate locus by connecting respective coordinates.

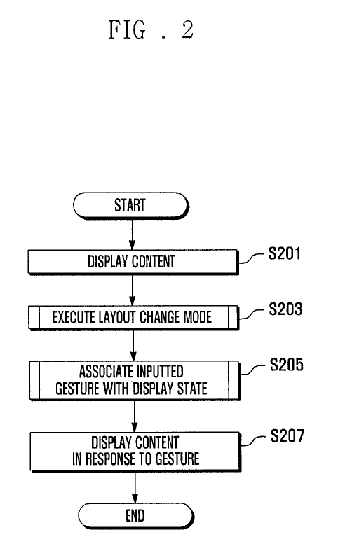

FIG. 2 is a flowchart illustrating a process of arranging and displaying content according to an exemplary embodiment of the present invention.

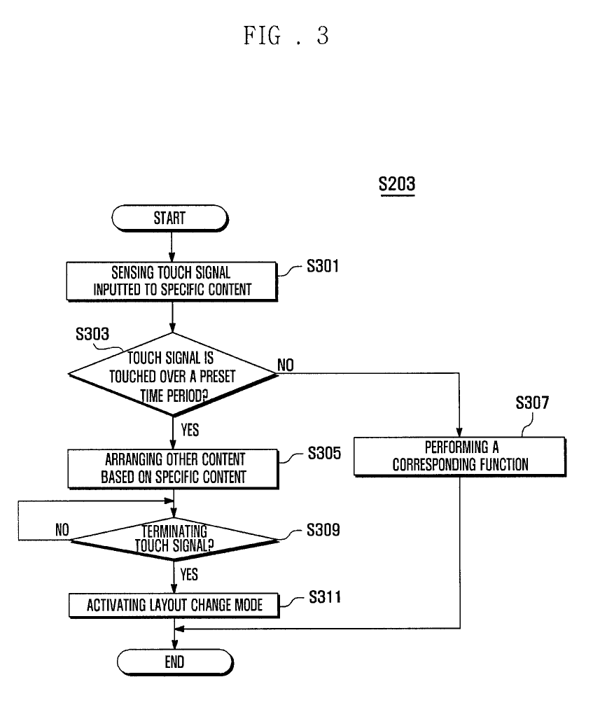

Referring to FIG. 2, the controller 100 can control the display window 114 to display corresponding one or more content to screen in response to a request of user (S201). The content is various digital information which is provided through communications network such as internet or provided after being previously stored, and can include various media which can be displayed on the screen of a terminal such as information content, or program, photograph, movie, music and text which are processed into digital. Moreover, the number of content displayed on screen can be set in the terminal. When one or more content is displayed, the controller 100 can execute the layout change mode for changing the display state of the content (S203). Here, the controller 100 can sense the layout change mode execution request from a touch signal. That is, in case an input of user that touches a specific content displayed on screen over a preset time is generated, the controller 100 can recognize this as an execution request for the layout change mode. If the layout change mode execution request is recognized, the controller 100 arranges other content based on the specific content corresponding to coordinate value to which the touch signal is inputted. The layout change mode is illustrated in detail with reference to FIG. 3.

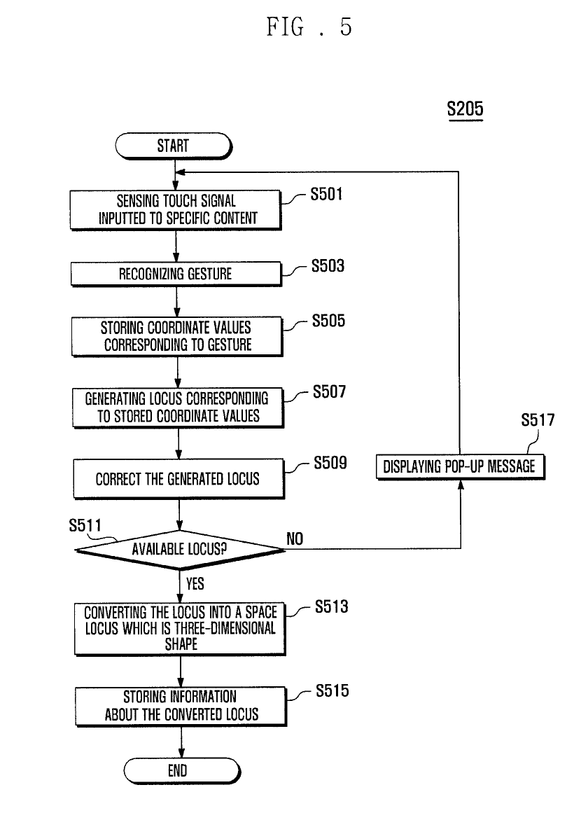

If the layout change mode is executed, the controller 100 can associate gesture inputted by the user with the display state (S205). At this time, the controller 100 can generate locus corresponding to gesture inputted by user. In the layout change mode, the controller 100 can sense touch signal inputted to a specific content from the user. The coordinate corresponding to the touch signal can be touch start coordinate value corresponding to the gesture of user. Thereafter, the controller 100 can recognize the gesture operation of user. Here, the user can input various gestures. If gesture is inputted, the controller 100 detects coordinates corresponding to the further inputted gesture and stores it in the storage unit 120, then connects the stored coordinates to generate locus using the locus calculation unit 102. The generation of locus will be illustrated in detail in FIG. 5.

If locus is generated, the controller 100 performs the process of correcting the locus. The controller 100 can correct coordinate values corresponding to the gesture of user into standardized locus using a correction program. If locus is corrected, the controller 100 determines whether the corrected locus is a locus which is available in the terminal. That is, the controller 100 determines whether the corrected locus is similar to a locus shape which is previously stored in terminal. The controller 100 can previously store information about gesture having a curve shaped user's touch signal and gesture having a straight line shaped user's touch signal. If the corrected locus is available from the previously stored value, the controller 100 converts the locus into a space locus which is three-dimensional shape to display one or more content in three dimensions. Here, the controller 100 may add height (z axis) to plane coordinates value which is comprised of width (x axis) and length (y axis) which are inputted from the touch screen 110. Thereafter, the controller 100 can arrange and display the content that corresponds to the gesture of user (S207). For example, If the gesture of user has a curve shape, the controller 100 displays content in the direction to which touch signal is inputted according to curve shape. If the gesture of user has a straight line shape, the controller 100 displays content in the direction to which touch signal is inputted according to straight line shape. The controller 100 can change at least one of the size of the content and the darkness of the content to display it in three dimensions according to the locus corresponding to the gesture of user. For example, the controller 100 displays content to be larger in a start coordinate value of the locus, while displaying content to be smaller as it goes away from the start coordinate value. The controller 100 displays content to be brighter in a start coordinate value of the locus, while displaying content to be darker as it goes away from the start coordinate value.

Moreover, if gesture is generated by user, the controller 100 can output sound effect by controlling the audio processing unit 130 during the process of arranging the content according to corresponding locus. The content can further be rearranged by re-entering the layout change mode again. The controller 100 can store the changed arrangement information of the content in the storage unit 120.

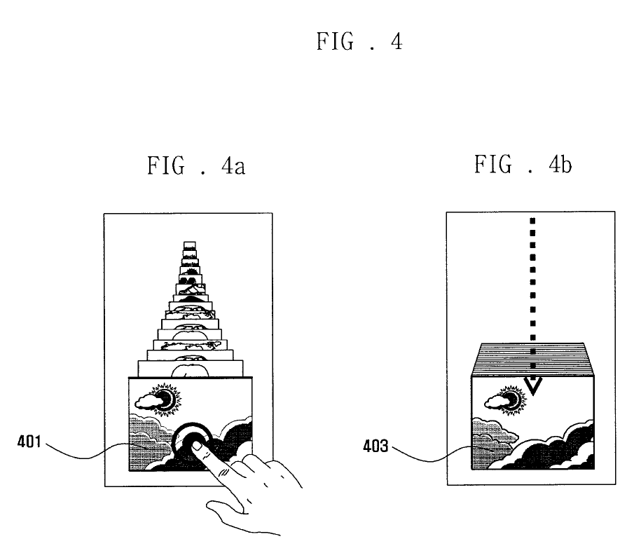

FIG. 3 is a flowchart illustrating an operation about layout change mode according to an exemplary embodiment of the present invention, FIGS. 4a and 4b are screens illustrating an operation about layout change mode according to an exemplary embodiment of the present invention.

Referring to FIGS. 3 to 4b, the controller 100 can execute the layout change mode according to the request of the user for changing the display state of one or more content. After one or more content which user requests are displayed, the controller 100 can sense touch signal inputted to a specific content (S301). Then, the controller 100 can determine whether the inputted touch signal is touched over a preset time (S303). At this time, if touch signal is continued over preset time, the controller 100 can arrange other content based on specific content to which the touch signal is inputted (S305). Here, the other content can include the rest of the content excluding the specific content to which the touch signal is inputted among the content displayed on screen. For example, as shown in FIG. 4a, the controller 100 can sense that touch signal is inputted to a specific content 401. If touch signal is sensed over a preset time period, the controller 100 can arrange and display other content behind the specific content 403 in sequence, as shown in FIG. 4b. In the meantime, in the exemplary embodiment of the present invention, if the sensed touch signal is not continued over the preset time period, the controller 100 performs other function related to the inputted touch signal (S307). For example, if the inputted touch signal is a flick signal, flit signal or swing signal, the controller 100 can implement corresponding function which is set in terminal. Note that the controller 100 can sense an inputted drag and drop signal, after the touch signal is generated over preset time in specific content so as to execute the layout change mode. At this time, if the drag and drop signal is sensed, the controller 100 moves the specific content to location in which drop signal is generated, and can execute the layout change mode from the location in which the drop signal is generated.

After the content is arranged and displayed, the controller 100 can determine whether the touch signal is terminated (S309). If the touch is terminated, the controller 100 can activate the layout change mode (S311). In the meantime, in case the touch signal of user is not terminated, the controller 100 can continuously check whether the touch signal is terminated.

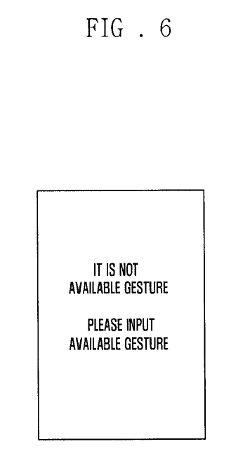

FIG. 5 is a flowchart illustrating a locus generation process corresponding to gesture according to an exemplary embodiment of the present invention. FIG. 6 is a screen illustrating a locus generation process corresponding to gesture according to an exemplary embodiment of the present invention.

Referring to FIGS. 5 and 6, the controller 100 can generate a locus corresponding to the gesture of user. At this time, the controller 100 can associate the display state of content with inputted gesture. If the layout change mode is executed, the controller 100 can sense touch signal inputted to a specific content (S501). At this time, if touch signal is sensed, the controller 100 can recognize the gesture of user based on the touch signal (S503). Here, the gesture can be a continuous movement action for touch signal which is inputted by user. The terminal can prestore standardized gestures including various forms of actions for subsequent recognition. If the gesture is recognized, the controller 100 can extract and store the coordinate values corresponding to the detected gesture (S505). Here, the controller 100 stores coordinate values of location in which touch signal is generated by the gesture of user, from touch start coordinate value corresponding to location in which touch signal is initiated to the coordinate value of location in which touch signal is terminated. If coordinate values are stored, the controller 100 generates locus using the coordinate values (S507). Here, the locus calculation unit 102 can connect respective coordinates to generate locus. If locus is generated, the controller 100 can correct the generated locus (S509). At this time, the controller 100 performs the process of correcting the locus by using a correction program which standardizes straight line or curve shape existing in a certain range. If the locus is corrected, the controller 100 determines whether the corrected locus is a locus which is available in terminal (S511). That is, the controller 100 determines whether the corrected locus is similar to the standardized locus shape which is previously stored in storage unit 120. Moreover, the controller 100 can control the display window 114 to display the locus on screen. The displayed locus may be overlaid with at least one of a background image and the content.

If the corrected locus is an available locus, the controller 100 may convert the corrected locus into space locus which is three-dimensional shape (S513). Here, the space locus is a locus which is generated by adding height value to plane coordinates value which is inputted to touch screen 110. The space locus can be used for arranging one or more content. The controller 100 can change at least one of the size of the content and the darkness of the content to display contents in three dimensions according to the locus corresponding to the gesture of user. If locus is converted, the controller 100 can control the storage unit 120 to store information about the converted locus (S515). That is, the controller 100 may change a display state of the contents without the converting of a locus when the similar gesture of user is input. In the meantime, if the locus is an unavailable locus, the controller 100 can control the display window 114 to display a pop up message on screen (S517). For instance, as shown in FIG. 6, the controller 100 can control the display window 114 to display a message “it is not available gesture, please input another gesture” which informs that the gesture inputted by user is not available, to screen.

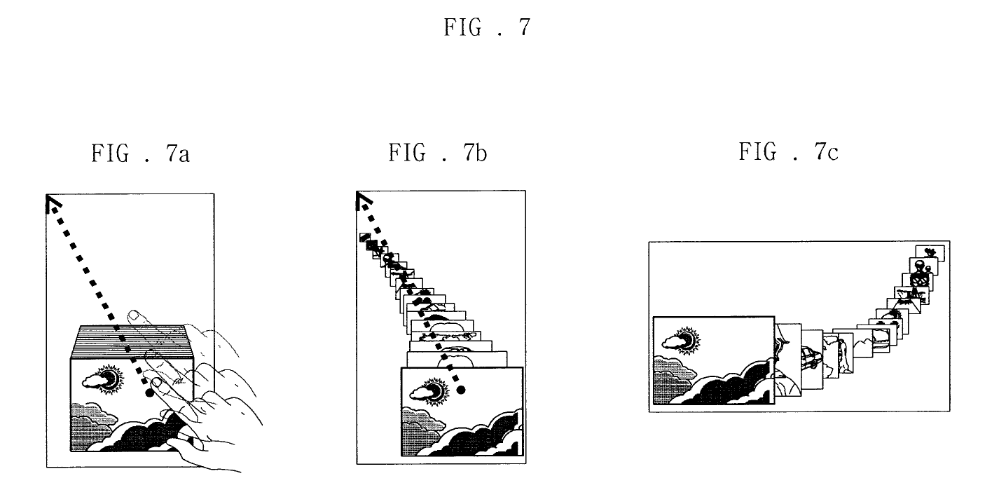

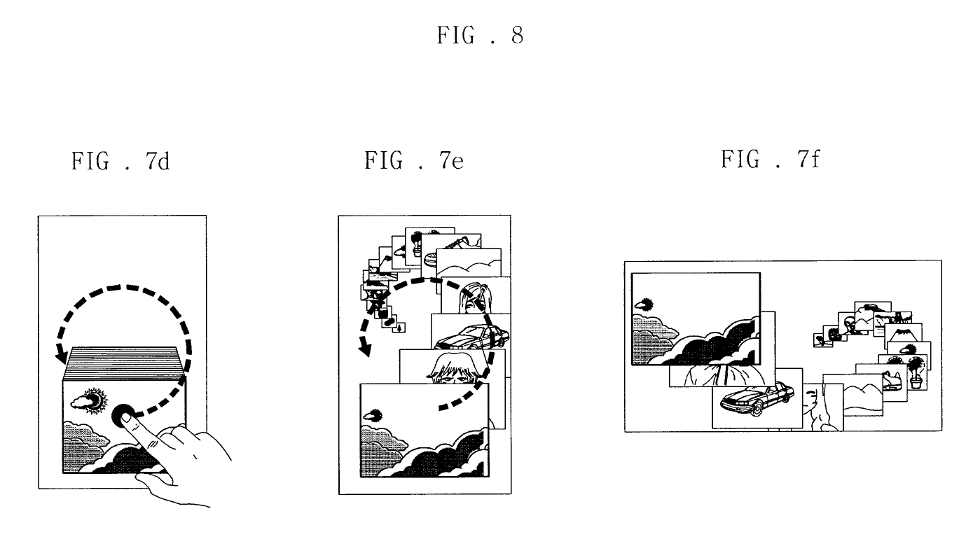

FIGS. 7a to 7f are screens arranging one or more content according to an exemplary embodiment of the present invention.

Referring to FIGS. 7a to 7f, the controller 100 can arrange and display content according to locus corresponding to the gesture of user. As shown in FIG. 7a, the controller 100 can sense touch signal by the gesture of user moving in the straight line direction. At this time, the controller 100 can detect and store touch coordinate values corresponding to the gesture. Then, as shown in FIG. 7b, the controller 100 can arrange and display content according to locus corresponding to the stored coordinates. That is, the controller 100 can display content according to the gesture which is inputted by user.

In the meantime, the controller 100 can sense the rotation of terminal in the state where content is arranged and displayed in response to the gesture of user. In response, the controller 100 can sense the rotation direction of terminal by using the output of sensor which can sense rotation, rearrange the content according to the rotation direction to display on screen. For example, as shown in FIG. 7c, the controller 100 can rearrange content which is arranged and displayed in response to the gesture of user according to the rotation direction, and display the rearranged content on screen.

Moreover, as shown in FIG. 7d, the controller 100 can sense a touch signal equivalent of a curved gesture from the user. In response, the controller 100 can detect and store touch coordinates values corresponding to the gesture. And, as shown in FIG. 7e, the controller 100 can arrange and display content according to locus corresponding to the stored coordinates. The controller 100 can sense the rotation of terminal in the state where the content is arranged and displayed in response to the gesture of user. For example, as shown in FIG. 7f, the controller 100 can rearrange content which is arranged and displayed in response to the curved finger gesture of a user, and display the rearranged content on screen according to the rotation direction of the gesture.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of displaying one or more content of a terminal having a touch screen, the method comprising:
detecting a gesture on or about the touch screen during a mode for changing a display state of the one or more content;
associating the gesture with the display state of the content; and
displaying the one or more content according to the associated gesture.

2. The method of claim 1, wherein the gesture is a moving action continuously inputted by a user.

3. The method of claim 1, wherein further comprises:
determining whether a touch signal for a specific content is continued over a preset time period among the one or more content;
if so, arranging remaining contents in sequence behind the specific content; and
executing the mode for changing a display state of the one or more content.

4. The method of claim 3, further comprising:
executing a mode for changing a display state of the specific content when the touch signal is not continued over the preset time period.

5. The method of claim 1, wherein the associated gesture is one of a straight line finger movement and a curved finger movement on or about the touch screen.

6. The method of claim 1, wherein detecting the gesture comprises:
generating coordinate values corresponding to the gesture; and
calculating a locus by using the coordinate value.

7. The method of claim 6, wherein the locus is a path for coordinate values corresponding to the gesture of a user.

8. The method of claim 6, wherein calculating the locus corresponding to the coordinate values further comprises:
correcting the calculated locus;
comparing whether the corrected locus is similar to a plurality of standardized locus shapes which are previously stored; and
converting the corrected locus into a locus of three-dimensional space, if the corrected locus is similar to a previously stored standardized locus shape.

9. The method of claim 8, further comprising:
displaying a message of unavailability if the corrected locus is not similar to a previously stored standardized locus shape.

10. The method of claim 8, wherein the converting the corrected locus into a locus of three-dimensional space comprises at least one of:
adjusting a size of the one or more content;
adjusting a darkness of the one or more content; and
adding height value to plane coordinates of the correct locus.

11. The method of claim 1, wherein displaying the one or more content according to the associated gesture comprises:
rotating and rearranging the one or more content according to a rotation direction sensed via a sensor.

12. An apparatus for displaying one or more content of a terminal, comprising:
a touch screen having a touch pad and a display window for detecting a movement of a gesture and displaying the one or more content according to a preset arrangement; and
a controller controlling a display state of the one or more content by: associating the gesture with the display state of the content; and displaying of the one or more content according to the associated gesture.

13. The apparatus of claim 12, wherein the gesture is a moving action continuously inputted by a user.

14. The apparatus of claim 12, wherein the controller arranges remaining contents in sequence behind a specific content continuously selected over a preset time period, and executes a mode for changing a display state of the one or more content.

15. The apparatus of claim 14, wherein the controller executes a mode for changing a display state of the specific content if the selection of the specific content is not continued over the preset time period.

16. The apparatus of claim 12, further comprising a storage unit which stores a coordinate values corresponding to the gesture.

17. The apparatus of claim 16, wherein the controller comprises a locus calculation unit which calculates the locus using the stored coordinate values.

18. The apparatus of claim 17, wherein the locus calculation unit corrects the calculated locus, and converts the corrected locus into a locus of three-dimensional shape in case the corrected locus is similar to a plurality of previously stored standardized locus shapes.

19. The apparatus of claim 18, wherein the controller adjusts at least one of a size of the one or more content and a darkness of the one or more content and arranges the one or more content in three dimensions according to the corrected locus.

20. The apparatus of claim 18, wherein the controller adds height value to plane coordinates of the correct locus.

21. The apparatus of claim 18, wherein the controller controls a display window to display a message of unavailability when the corrected locus is not similar to a previously stored standardized locus shape.

22. The apparatus of claim 12, wherein the controller rearranges the one or more content according to a rotation direction sensed via a sensor.
